(19) United States
(12) Patent Application Publication
(10) Pub. No.: US 2014/0123621 A1
(43) Pub. Date: May 8, 2014

(54) ACTUATED BYPASS HOOD FOR GAS TURBINE AIR INLET SYSTEM AND METHODS

(71) Applicant: Donaldson Company, Inc., (US)

(72) Inventors: Robin Driessens, Herent (BE); Erwin Jean Marie Verbelen, Meise (BE); Jimmy Vanderlinden, Herent (BE); Jon Haag, Vadnais Heights, MN (US)

(73) Assignee: Donaldson Company, Inc., Minneapolis, MN (US)

(21) Appl. No.: 13/776,095

(22) Filed: Feb. 25, 2013

Related U.S. Application Data
(60) Provisional application No. 61/724,184, filed on Nov. 8, 2012.

(51) Int. Cl. F02C 7/055; B23P 11/00

(52) U.S. Cl. CPC F02C 7/055; B23P 11/00
USPC 60/39.092; 29/889.22

(57) ABSTRACT

An inlet hood for use with a gas turbine or compressor air inlet system includes a frame and at least one pre-filter pivotably held by the frame in an operating position. The pre-filter is pivotable to a bypass position angled relative to the operating position. Methods of assembly and use are provided.

### TECHNICAL FIELD

This disclosure relates to inlet air treatment systems, and more specifically, to systems and methods for bypassing inlet air pre-filter systems for gas turbine air inlet systems or for compressor air inlet systems.

### BACKGROUND

Although principles of this disclosure may be applied in a variety of applications, it was developed for use with gas turbine filter systems, and can be used in other air intake designs, particularly those demanding large volumes of air, such as compressors. At least some gas turbine systems include inlet air treatment systems that remove moisture and/or dust from air entering therein. At least some known inlet air filtration systems include pre-filters that remove moisture from intake air, and final filters that remove dust and debris from intake air.

During normal operating conditions, it is desired to have the inlet air treatment system channel filtered air to the turbine generator with little air disruption and pressure drop through the inlet air treatment system. Over time, the pressure drop across pre-filters and the debris filter may increase which may result in reducing an amount of air flow to the turbine and reducing the operating efficiency of the turbine. In some known systems, pre-filters need to be removed manually to be cleaned, which may require a shutdown of the turbine for a long period of time.

Improvements are desirable.

### SUMMARY

An inlet hood for use with a gas turbine or compressor air inlet system is provided. The inlet hood includes a frame securable to a gas turbine air inlet system. The frame defines an opening. At least one pre-filter is pivotably held by the frame in an operating position covering the opening of the frame. The pre-filter is pivotable to a bypass position relative to the operating position.

In another aspect, a gas turbine or compressor air inlet system is provided. The system includes an air filter enclosure and an inlet hood coupled in flow communication with the air filter enclosure. The inlet hood includes a frame defining an opening and at least one pre-filter pivotable held by the frame in an operating position covering the opening of the frame. The pre-filter is pivotable to a bypass position angled relative to the operating position. Air entering the system flows through the pre-filter and then flows to the air filter enclosure, when the pre-filter is in the operating position. Air bypasses the pre-filter and then flows to the air filter enclosure when the pre-filter is in the bypass position.

In another aspect, a method of assembling an inlet air filter assembly for use with a gas turbine or compressor system is provided. The method includes coupling an inlet hood having a frame with an opening to an air filter enclosure; such that an air flow path is defined between the inlet hood and the air filter enclosure. There is a step of coupling a pre-filter to the frame such that the pre-filter is pivotably positioned between an operating position in which the pre-filter is within the air flow path, and a bypass position in which the pre-filter is angled relative to the operating position.

### BRIEF DESCRIPTION OF THE DRAWINGS

FIG. 1 is a schematic cross-sectional view of a gas turbine air inlet system, utilizing inlet hoods made in accordance with principles of this disclosure;

FIG. 2 is a schematic, perspective view of an inlet hood usable with the gas turbine air inlet system of FIG. 1, constructed in accordance with principles of this disclosure;

FIG. 3 is a schematic, perspective view of the inlet hood of FIG. 1, and showing the pre-filters pivoted to a bypass position, constructed in accordance with principles of this disclosure;

FIG. 4 is a top view of the portion of the inlet hood of FIG. 2, showing the pre-filters in the operating position;

FIG. 5 is a top view of the portion of the inlet hood illustrated in FIG. 3 showing the pre-filters in the bypass position; and

FIG. 6 is a schematic front view of the inlet hood of FIG. 3, showing the pre-filters in the bypass position;

FIG. 7 is a schematic front view of the inlet hood of FIG. 2, showing the pre-filters in the operating position;

FIG. 8 is a perspective view of the inlet hood of FIG. 2;

FIG. 9 is a front view of the inlet hood of FIG. 8;

FIG. 10 is a schematic cross-sectional view of the inlet hood of FIGS. 8 and 9, the cross-section being taken along the line A-A of FIG. 9;

FIG. 11 is an enlarged view of portion B of the cross-section of FIG. 10; and

FIG. 12 is a schematic cross-sectional view of the inlet hood of FIGS. 8-10, the cross-section being taken along the line C-C of FIG. 10.

### DETAILED DESCRIPTION

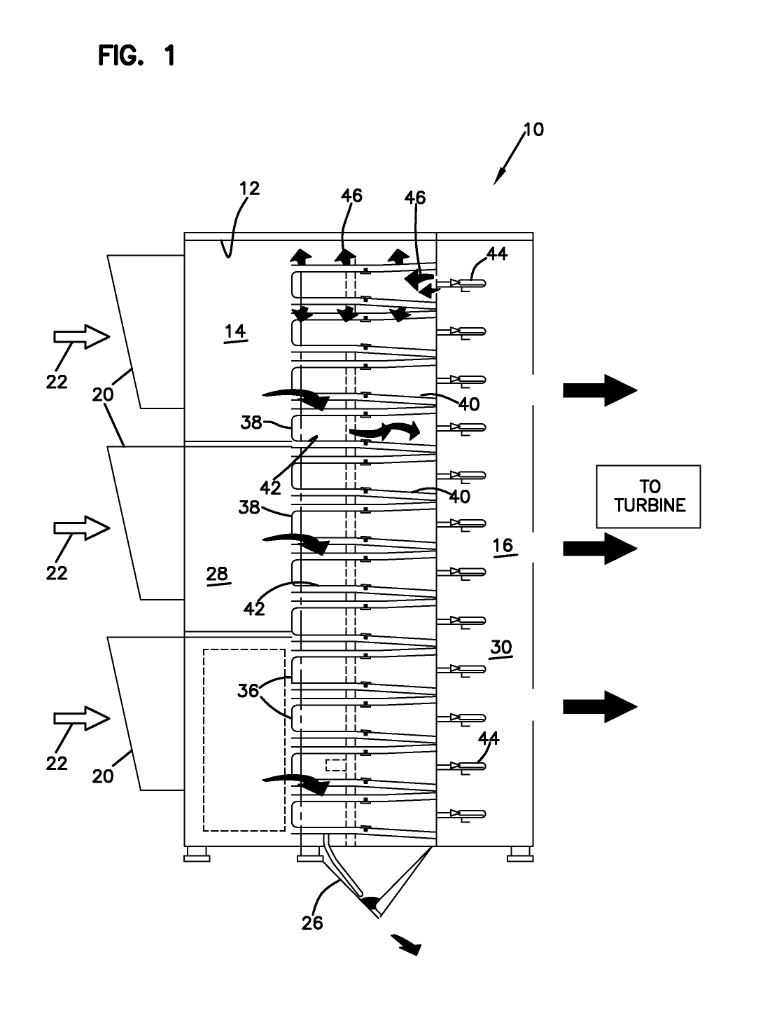

A. Example System, FIG. 1

In FIG. 1, a gas turbine air inlet system is shown at 10. The system 10 includes an air filter enclosure 12 having an air inlet side 14 and an air outlet side 16. Air enters the air filter chamber 12 through a plurality of vertically spaced inlet hoods 20 positioned along the air inlet side 14. The inlet hoods function to protect the system 20 from the effects of rain, snow, ice, sleet, and sun. Air entering the inlet hoods 20 is indicated by arrow 22. Some of the dust within the air filter chamber 12 falls by gravity toward a dust collection hopper 26 located at the bottom of the air filter enclosure 12.

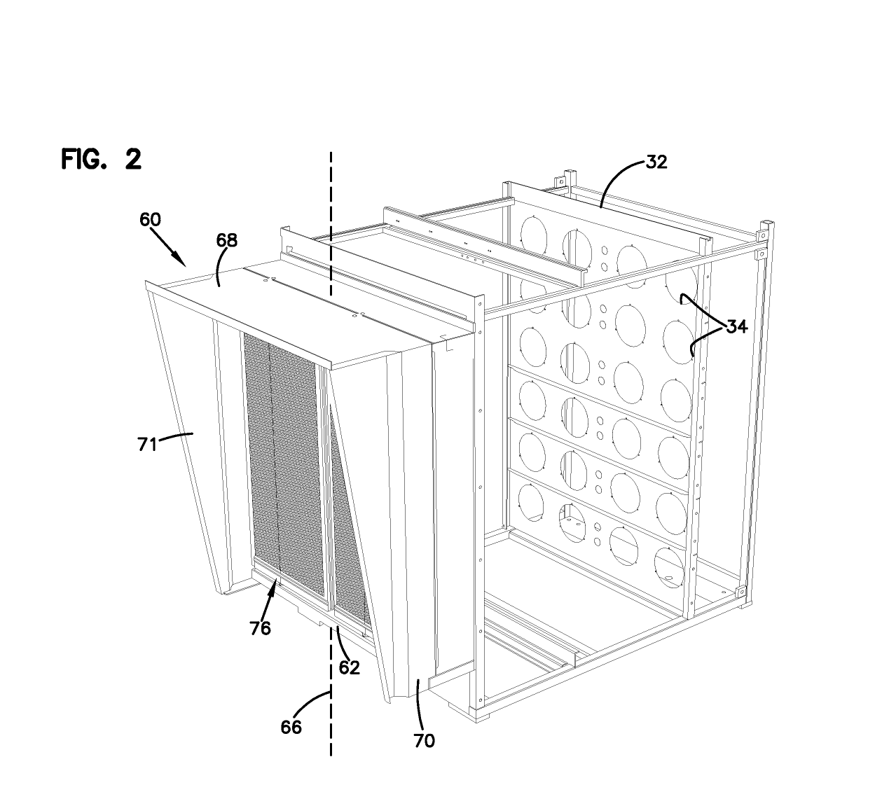

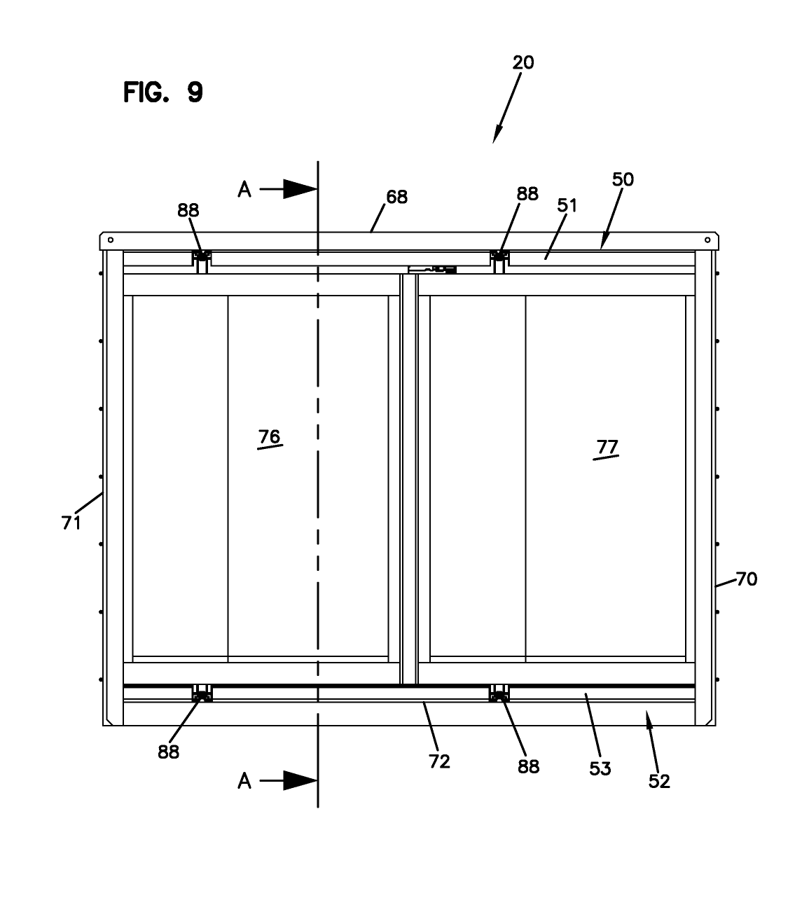

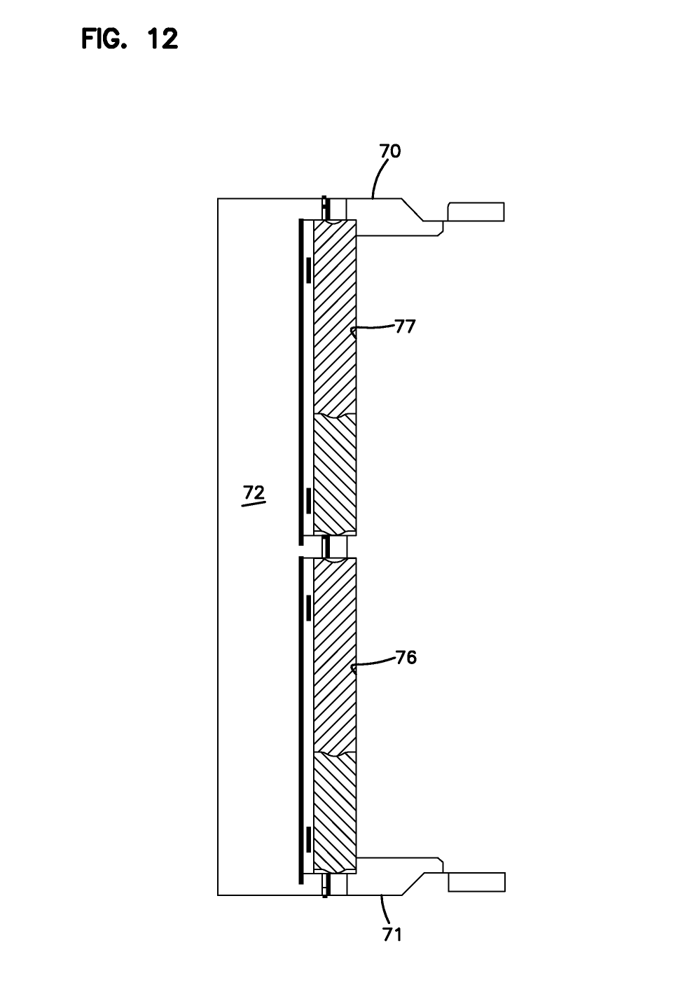

Within each of the hoods 20 is a pre-filter (FIGS. 2-14) coupled thereto. More details on the pre-filter and bypass system is described further below.

The air filter chamber 12 is divided into upstream and downstream volumes 28, 30, by a partition or tubesheet 32. The upstream volume 28 generally represents the dirty air section of the system 10, while the downstream volume 30 generally represents the clean air section of the system 10. The tubesheet 32 defines a plurality of apertures 34 (FIGS. 2, 3, and 8) for allowing air to flow from the upstream volume 28 to the downstream volume 30. Each aperture 34 is covered by an air filter 36 or filter cartridge located in the upstream volume 28 of the air filter enclosure 12. The filters 36 are arranged and configured such that air flowing from the upstream volume 28 to the downstream volume 30 passes through the filters 36 prior to passing through the apertures 34.

In this example, each air filter 36 includes a pair of filter elements. For example, each air filter 36 includes a cylindrical element 38 and a somewhat truncated, conical element 40. Each truncated, conical element 40 includes one end having a major diameter and another end having a minor diameter. The cylindrical element 38 and the truncated conical element 40 of each filter 36 are co-axially aligned and connected end to end with the minor diameter end of each conical element 40 being secured to one of the cylindrical elements 38 in a sealed manner. The major diameter end of each truncated, conical element 40 is secured to the tubesheet 32 such that a seal is formed around its corresponding aperture 34. Each filter 36 is generally co-axially aligned with respect to its corresponding aperture 34 and has a longitudinal axis that is generally horizontal.

In general, during filtering, air is directed from the upstream volume 28 radially through the air filters 36 and into interior volumes 42 of the filters 36. After being filtered, the air flows from the interior volumes 42 through the tubesheet 32 by way of the apertures 34 and into the downstream clean air volume 30. The clean air is then drawn out of the downstream volume 30 and into a gas turbine intake, not shown.

The apertures 34 of the tubesheet 32 includes a pulse jet air cleaner 44 mounted in the downstream volume 30. Periodically, the pulse jet air cleaner 44 is operated to direct a pulse jet of air backwardly through the associated air filter 36, i.e. from the interior volume 42 of the filter 36 outwardly to dislodge particulate material trapped in or on the filter media of the air filter 36. The pulse jet air cleaners 44 can be sequentially operated from the top to the bottom of the air filter enclosure 12 to eventually direct the dust particulate material blown from the filters 36 into the lower hopper 26 for removal. The arrows shown at 46 illustrate the pulse of air from the pulse jet air cleaner 44 being directed into volume 42 and then from the downstream side of the air filter 36 to the upstream side of the air filter 36.

The system 10 illustrated is just an example. A variety of gas turbine filter housing systems, both self-cleaning or static, can be used. In addition, the system 10 can be an air inlet system 10 for a compressor.

B. Example Inlet Hood, FIGS. 2-12

Turning now to FIGS. 2-12, the inlet hood 20 constructed in accordance with principles of this disclosure is described in further detail. The inlet hood 20 is usable with an inlet system for a gas turbine, as shown in FIG. 1, or with a compressor air inlet system.

Located within each of the inlet hoods 20 is a pre-filter assembly 60 having at least one pre-filter 76. In the example shown, there are at least two pre-filters 76, 77 as part of the assembly 60, and in other arrangements, there could be only a single pre-filter 76, only two pre-filters 76, or more than two pre-filters 76. The pre-filter 76 can be made of a variety of materials. For example, the pre-filter 76 can be made from metal louvers, which is useful for catching and coalescing moisture droplets. Many other materials can be used. For example, the pre-filter 76 can include a plastic droplet catcher or mist eliminator, such as those sold by Munters, described at: http://www.munters.comien/Global/Products-Services/Mist-Elimination/Air-Intake/.

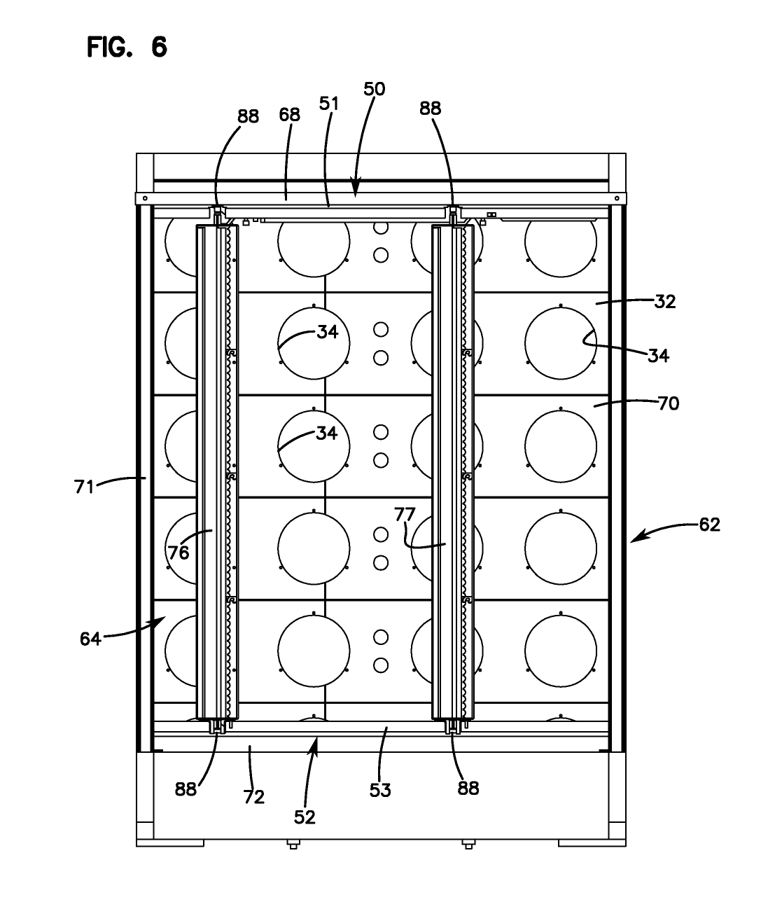

The inlet hood 20 in the example shown includes a frame 62 for holding the pre filters 76. The frame 62 can be, for example, generally rectangular (or other shapes in other examples) and define an opening with 64 (FIG. 6) within the boundary or perimeter of the frame 62.

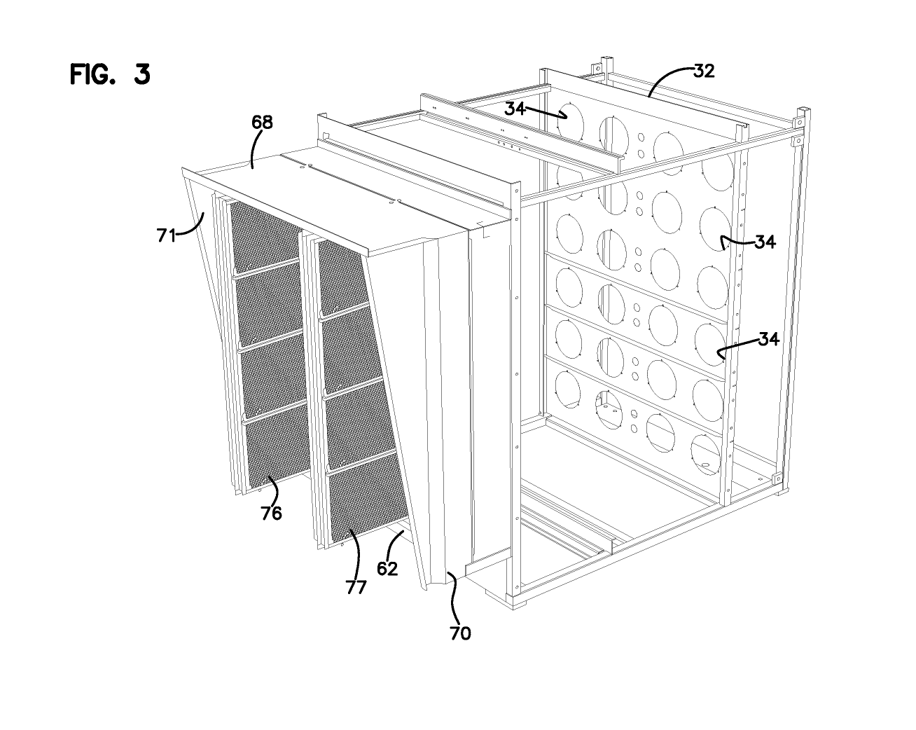

As can be seen in the example in FIGS. 2 and 3, the frame 62 is vertical relative to a horizontal mounting surface of the system 10. The frame defines a vertical axis 66 (FIG. 2) that is generally perpendicular or normal to the horizontal mounting surface of the system 10, in the example shown. There can be variations—for example, relative to the horizontal mounting surface of the system 10, the frame can vary at or between 0° (e.g., a horizontal frame) and about 90° (+/−10°). In some example arrangements, the frame 62 is generally parallel to the tubesheet 32. In other examples, the frame 62 need not be parallel to the tubesheet 32.

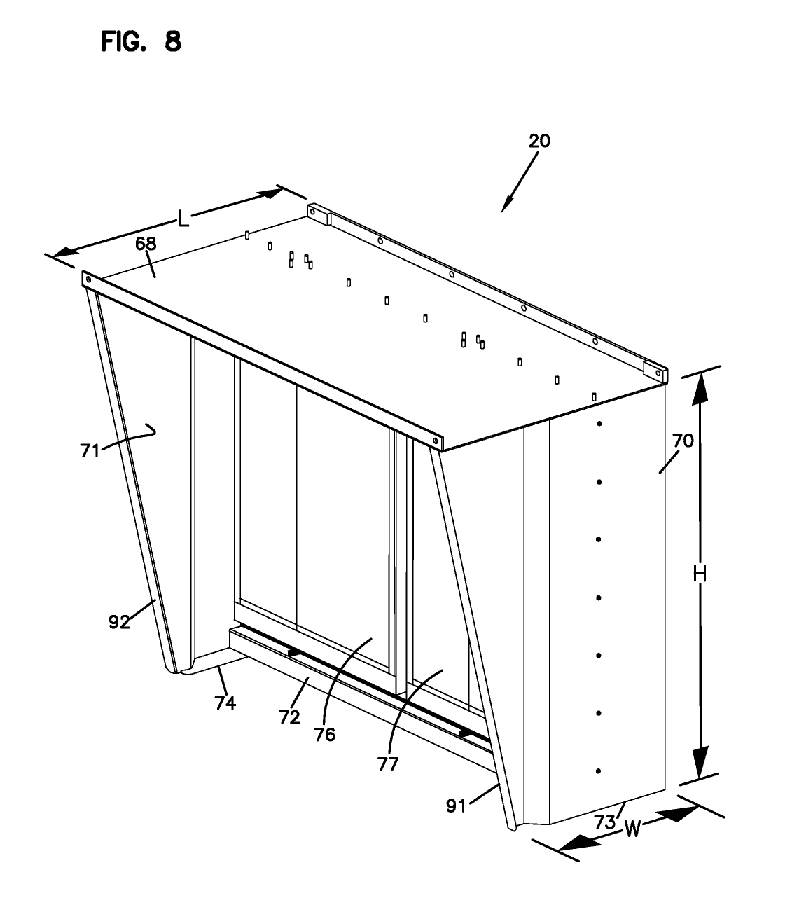

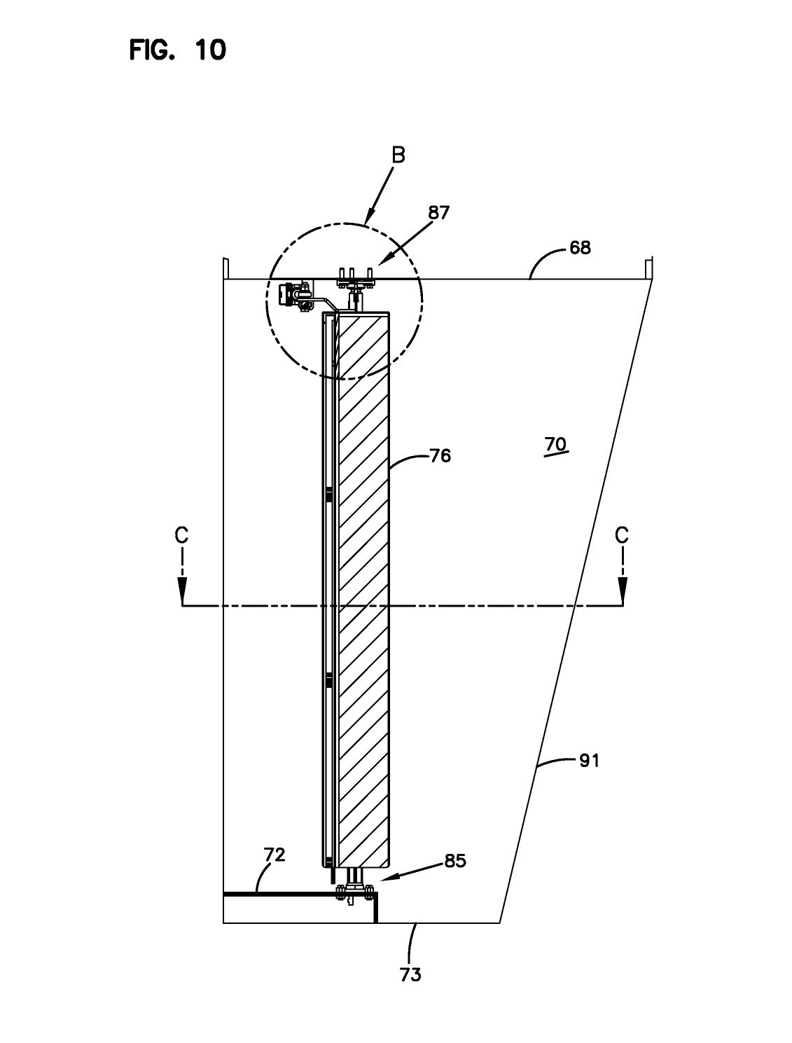

The frame 62 can be arranged relative to the rest of the system 10 to provide that the direction of flow of inlet air, such as that shown at arrows 22 in FIG. 1, is, in one example, generally perpendicular to the face of the frame 62. By the term “face of the frame,” it is meant the area within the perimeter of the frame 62. In other examples, the frame 62 is arranged so that the direction of flow of inlet air 22 is about 80°-120° to the face of the frame 62. In the example shown, the frame 62 is formed by an upper hood member 68 and opposite side panels 70, 71 on opposite sides of the upper hood member 68. In the example shown, the side panels 70, 71 are generally perpendicular to the upper hood member 68, but other angles are possible. A lower hood member 72 (FIG. 10) is opposite of the upper hood member 68 and extends between the side panels 70, 71. In the example shown, the lower hood member 72 is shorter in length than the upper hood member 68 and shorter than a length of a bottom edge 73, 74 (FIGS. 8 and 10) of the side panels 70, 71, respectively. Together, the upper hood member 68 and side panels 70, 71 function to help protect the pre-filter assembly 60 from snow, ice, sleet, rain, and the sun.

A seal member 50, for example, a brush 51 (FIG. 6), is provided between the pre-filter 76 and an inside surface of the upper hood member 68 to inhibit the flow of air between the upper hood member 68 and the pre-filter 76. Similarly, a seal member 52, for example, a brush 53, is provided between the pre-filter 76 and an inside surface of the lower hood member 72 to inhibit the flow of air between the upper hood member 68 and the pre-filter 76. Other seal members can be used, for example, gaskets, lip seal members, etc.

The pre-filter 76 is pivotably held by the frame 62 in an operating position that covers the opening 64 of the frame 62. The operating position of the pre-filter 76 is shown in FIGS. 2, 4, 7-10, and 12.

The pre-filter 76 is pivotable to a bypass position that is angled relative to the operating position. FIGS. 3, 5, and 6 show the pre-filter 76 in the bypass position.

Preferably, the pre-filter 76 is pivotable at an angle relative to the operating position so that there is a large opening to permit the flow of air and allow it to bypass the pre-filter 76, without introducing undue turbulence or restriction into the system. The pre-filter 76 can open up to the bypass position for the full surface of the frame 62. This means that the complete pre-filter area occupied by the pre-filter 76 (when in the operating position) is bypassed by the incoming air, and as such, pressure drop over the inlet housing is reduced to a minimum. Any pressure drop that does result is caused by the shape of the inlet hood 20, and not by the type of pre-treatment, or its pollutant.

In the example shown in FIGS. 3, 5, and 6, the pre-filter 76 is pivotable to a bypass position that is angled relative to the operating position. For example, in many useful systems, the bypass position of the pre-filter 76 is angled at least 45° relative to the operating position of the pre-filter 76, and can be at least 60° in some examples, typically at least 70°. In some examples, the bypass position of the pre-filter 76 is angled relative to the bypass position no greater than 130°, and can be no greater than 110°, typically no greater than 100°. In some examples, a range of 50°-120° is useful, and in some examples, a range of 65-115°, for example about 70°-110°. To achieve many advantages of the system, the bypass position of the pre-filter 76 will be angled about 80-100°, for example, about 85-95° relative to the operating position, and typically can be about 90° relative to the operating position.

As can be appreciated by comparing FIGS. 2 and 3, the pre-filter 76 is pivotable about the vertical axis 66 (FIG. 2). In an example system, the pre-filter 76 has a flow face 78 that is generally parallel to the air filter enclosure 12, and can be parallel to the tubesheet 32, when the pre-filter 76 is in the operating position. When the pre-filter 76 is in the bypass position, the flow face 78 can be angled at least 60° in some examples, typically at least 70° relative to the air filter enclosure 12. In some examples, the flow face 78 can be angled no greater than 130°, and can be no greater than 110°, typically no greater than 100° relative to the air filter enclosure 12. In some examples, a range of 50°-120° is useful, and in some examples, a range of 65-115°, for example about 70°-110°. To achieve many advantages of the system, the flow face 78 can be angled about 80-100° relative to the air filter enclosure 12. In many systems, the flow face 78 will be angled 85-95° relative to the enclosure 12, and typically about 90° relative to the enclosure 12. In systems in which the tubesheet 32 is parallel to the frame 62, the flow face 78 can be angled, relative to the tubesheet 32: at least 60°, typically at least 70°, no greater than 130°, typically no greater than 110°; useful ranges include 50-120°, such as 65-115°, for example 70-110°. To achieve many advantages, in systems in which the tubesheet 32 is parallel to the frame 62, the flow face 78 can be angled relative to the tubesheet 32 in a range of 80-100°, often 85-95° typically about 90°, when the pre-filter 76 is in the bypass position.

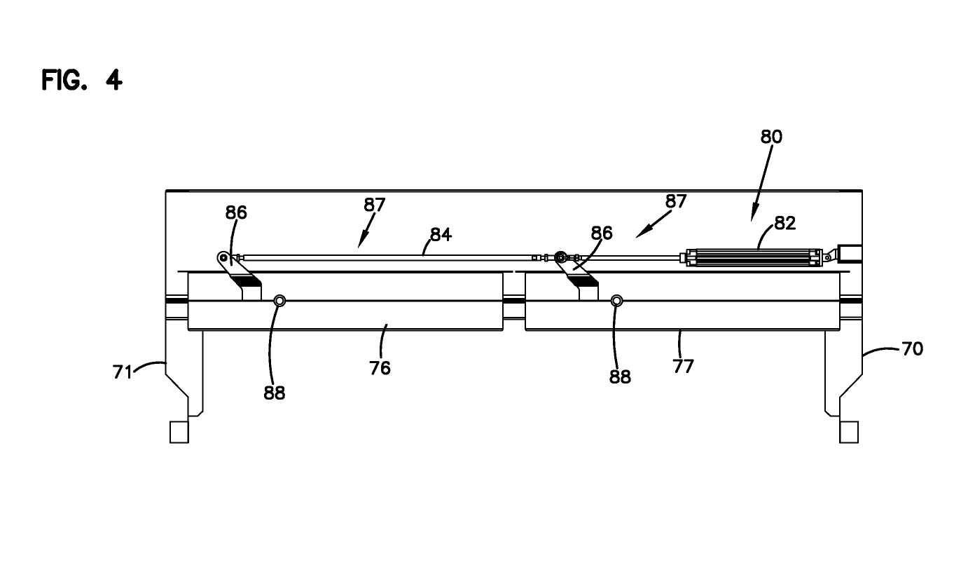

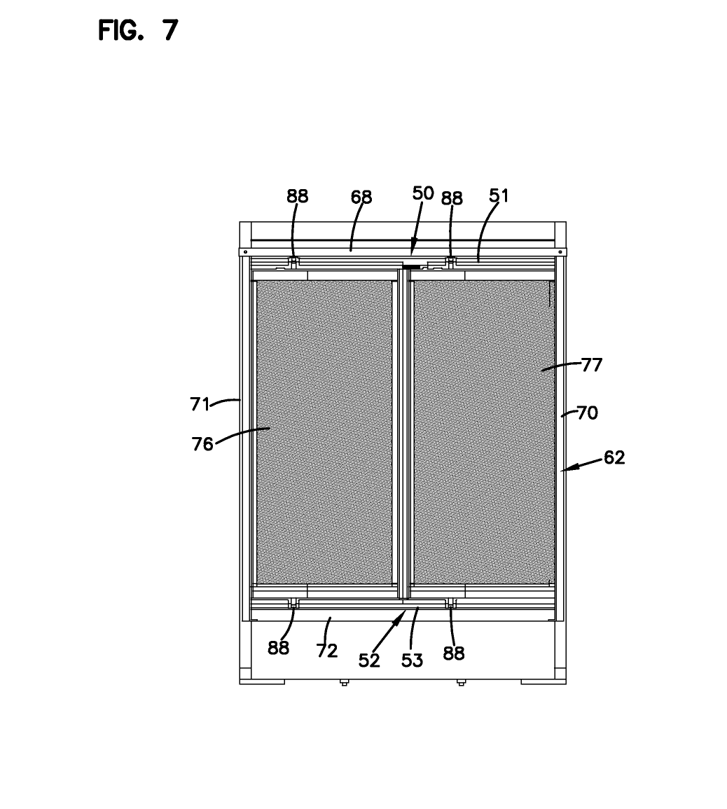

An actuator arrangement 80 can be used to control the pivoting of the pre-filter 76 between the operating position and the bypass position. For example, the actuator arrangement 80 can include a pneumatic cylinder 82 (FIGS. 4, 5, and 11). In other examples, the actuator arrangement can include a hydraulic cylinder, or servo motor, or any type of electrically driven actuator. The actuator arrangement 80 will be responsive to at least one sensor in the system 10 that measures temperature, or relative humidity, or pressure drop across the pre-filter 76. In some arrangements, there can be one sensor for each of these parameters. When the sensor is triggered because of a condition in the system 10 present affecting temperature, relative humidity, or pressure drop, it will cause the actuator arrangement 80 to move the pre-filter 76 from the operating position (FIG. 6) to the bypass position (FIG. 7).

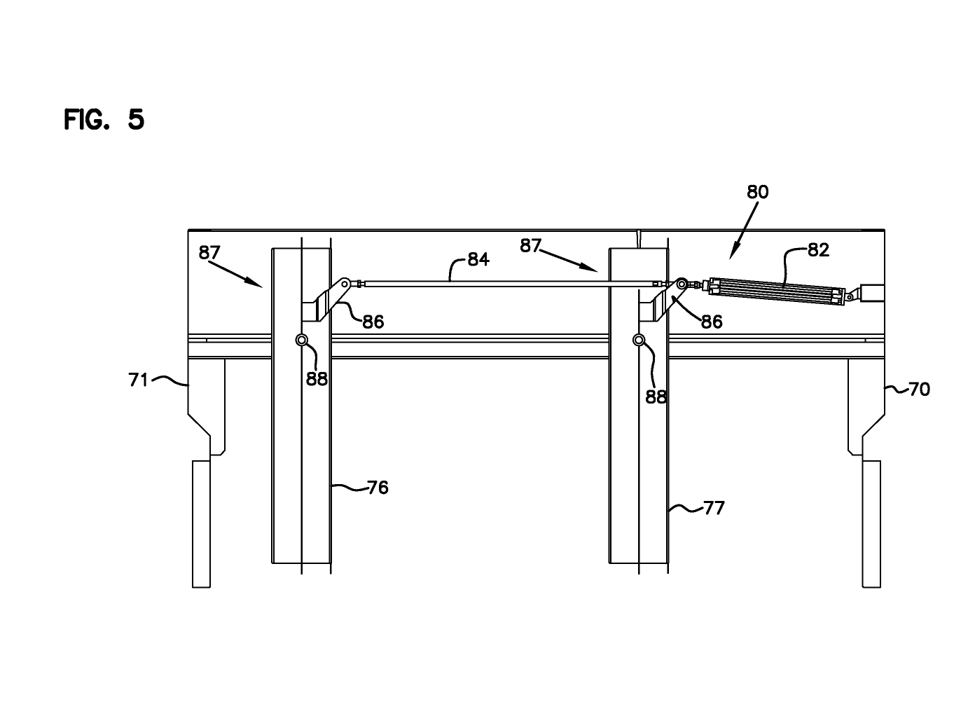

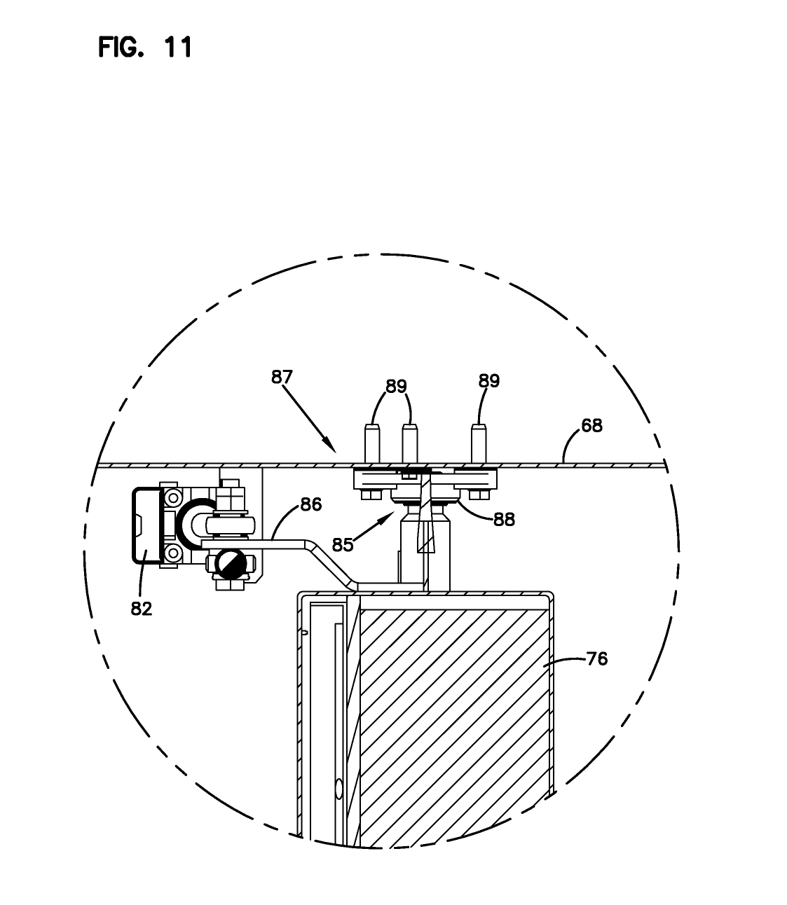

There are many arrangements possible how to pivot the pre-filter 76 between operating and bypass positions. One example pivot system is shown, in general, at 87. In the example pivot system 87 shown, the pneumatic cylinder 82 drives a rod 84 (FIGS. 4 and 5). A connector 86 (FIGS. 4, 5, 11) secures the rod 84 to the pre-filter 76. The pre-filter 76 is secured to the upper hood member 68 by a pivot connection 85 (FIG. 11), such as bearing 88. The bearing 88 is secured to the upper hood member by fasteners, such as bolts 89 (FIG. 11). Movement of the rod 84 by the pneumatic cylinder 82 causes the pre-filter 76 to pivot about the pivot connection 85 on the frame 62.

The pre-filter 76 can also include a pivot connection 85, such as bearing 88, between the pre-filter 76 and the lower hood member 72. In other examples, the actuator arrangement 80 can be adjacent to the lower hood member 72, rather than adjacent to the upper hood member 68.

In one example system, there is at least the second pre-filter 77 pivotably held by the frame 62 and pivotal between the operating position covering the opening 64 of the frame 62 and the bypass position. In the examples shown, it can be seen how the second pre-filter 77 is located immediately adjacent to the first pre-filter 76. In the example shown, the actuator arrangement 80 controls operation of both pre-filters 76, 77 simultaneously. In other arrangements, each pre-filter 76, 77 may be operated independently.

A method of assembling an air inlet assembly can be implemented using these principles. The method includes coupling the inlet hood 20 having frame 62 with an opening 64 to the air filter enclosure 12, such that an air flow path is defined between the inlet hood 20 and the air filter enclosure 12. The pre-filter 76 can be coupled to the frame 62 such that the pre-filter 76 is pivotably positioned between the operating position in which the pre-filter 76 is within the air flow path, and the bypass position in which the pre-filter 76 is angled relative to the operating position. The angle can be 80-100° relative to the operating position. The method can include coupling the actuator arrangement 80 to the pre-filter 76 to control pivoting of the pre-filter 76 between the operating position and the bypass position.

The step of coupling the pre-filter 76 to the frame 62 can include coupling the pre-filter 76 to the frame 62 so that the flow face 78 of the pre-filter 76 is generally parallel to the air filter enclosure 12, when the pre-filter 76 is in the operating position.

The method can include coupling a sensor to the pre-filter 76 for sensing at least one of temperature, relative humidity, and pressure drop. This sensor can communicate with the actuator arrangement 80 to control pivoting of the pre-filter 76.

In one example, the upper hood member 68 can have a length L (FIG. 8) of about 1100-1200 mm, for example, 1150 mm. The height H of the hood assembly 20 can be about 2500-2600 mm, for example, 2560 mm. The width W of the hood assembly 20 at the lower edges 73, 74 of side panels 70, 71 can be 700-800 mm, for example 745 mm. In the example shown, the side panels 70, 71 are generally trapezoidal, each including an inlet side edge 91, 92 (FIG. 8) that is angled inwardly from the upper hood member 68 as it extends down to the lower edges 73, 74.

In principle, any filter housing relying on some form of air pre-treatment in the form of droplet catchers, (marine) louvers, or pre-filters can make use of the principles disclosed herein. Similar air inlet bypass systems, such as those described herein, can be applied in other air intake system designs, and particularly those demanding large volumes of air, such as compressors

The above is a description of example principles. Many embodiments can be made.

What is claimed is:

1. An inlet hood for use with a gas turbine or compressor air inlet system; the inlet hood comprising:
(a) a frame defining an opening; and
(b) at least one pre-filter pivotably held by the frame in an operating position covering the opening of the frame; the pre-filter being pivotable to a bypass position that is angled at least 45° relative to the operating position.

2. The inlet hood of claim 1 wherein:
(a) the frame comprises an upper hood member, first and second side panels, and a lower hood member.

3. The inlet hood of claim 1 further comprising:
(a) an actuator arrangement controlling pivoting of the pre-filter between the operating position and the bypass position.

4. The inlet hood of claim 3 wherein:
(a) the actuator arrangement comprises a pneumatic cylinder.

5. The inlet hood of claim 1 further comprising:
(a) at least a second pre-filter pivotably held by the frame and being pivotable between an operating position covering the opening of the frame and a bypass position at least 45° relative to the operating position of the second pre-filter.

6. The inlet hood of claim 1 wherein:
(a) the pre-filter is pivotable to a bypass position that is angled no greater than 130° relative to the operating position.

7. The inlet hood of claim 1 wherein:
(a) the pre-filter is pivotable to a bypass position that is angled 80°-100° relative to the operating position.

8. A gas turbine or compressor air inlet system comprising:
(a) an air filter enclosure;
(b) an inlet hood coupled in flow communication with the air filter enclosure;
the inlet hood including:
(i) a frame defining an opening; and
(ii) at least one pre-filter pivotably held by the frame in an operating position covering the opening of the frame; the pre-filter being pivotable to a bypass position that is at least 45° relative to the operating position;
wherein air entering the system flows through the pre-filter and then to the air filter enclosure, when the pre-filter is in the operating position;
and air bypasses the pre-filter and then to the air filter enclosure when the pre-filter is in the bypass position.

9. The system of claim 8 wherein:
(a) the frame comprises an upper hood member, first and second side panels, and a lower hood member.

10. The system of claim 8 further comprising:
(a) an actuator arrangement controlling pivoting of the pre-filter between the operating position and the bypass position.

11. The system of claim 10 further comprising:
(a) at least one sensor for at least one of temperature, relative humidity, and pressure drop across the pre-filter; the actuator arrangement being responsive to the sensor.

12. The system of claim 10 wherein:
(a) the actuator arrangement comprises a pneumatic cylinder.

13. The system of claim 8 wherein:
(a) the frame is vertical relative to a horizontal mounting surface of the system; the frame defining a vertical axis; and
(b) the pre-filter being pivotable about the vertical axis.

14. The system of claim 8 wherein:
(a) the pre-filter has a flow face generally parallel to the air filter enclosure, when the pre-filter is in the operating position.

15. The system of claim 8 wherein:
(a) the pre-filter has a flow face that is angled 80-100° relative to the air filter enclosure when the pre-filter is in the bypass position.

16. The system of claim 8 wherein:
(a) the pre-filter is pivotable to a bypass position that is angled at least 70° relative to the operating position.

17. The system of claim 8 wherein:
(a) the pre-filter is pivotable to a bypass position that is angled 80°-100° relative to the operating position.

18. A method of assembling an inlet air filter assembly for use with a gas turbine or compressor air inlet system; the method comprising:
(a) coupling an inlet hood having a frame with an opening to an air filter enclosure, such that an airflow path is defined between the inlet hood and the air filter enclosure; and
(b) coupling a pre-filter to the frame such that the pre-filter is pivotably positioned between: (i) an operating position in which the pre-filter is within the airflow path; and (ii) a bypass position in which the pre-filter is at least 45° relative to the operating position.

19. The method of claim 18 further comprising:
(a) coupling an actuator to the pre-filter to control pivoting of the pre-filter between the operating position and the bypass position.

20. The method of claim 18 wherein:
(a) the step of coupling a pre-filter to the frame includes coupling the pre-filter to the frame so that a flow face of the pre-filter is generally parallel to the air filter enclosure, when the pre-filter is in the operating position.
